(19) United States
(12) Patent Application Publication
(10) Pub. No.: US 2026/0351233 A1
(43) Pub. Date: Nov. 5, 2026

(54) Active Noise Cancellation With Reduced Distortion

(71) Applicant: Bang & Olufsen A/S, Struer (DK)

(72) Inventors: Geoff MARTIN, Holstebro (DK); Martin SCHOERKMAIER, Stattegg (DK)

(21) Appl. No.: 19/644,329

(22) Filed: Apr. 10, 2026

(30) Foreign Application Priority Data
May 2, 2025 (EP) 25173967.8

(51) Int. Cl. G10K 11/178

(52) U.S. Cl. CPC G10K 11/17881; G10K 11/17854

(57) ABSTRACT

The present disclosure relates to a method for performing active noise cancellation for a loudspeaker system. The method comprises obtaining an audio content signal and at least one noise signal. The method comprises determining an audio content signal level, determining a noise signal level, and calculating a total signal level. The method further comprises comparing a total signal level to the signal level threshold. In response to the total signal level being below the signal level threshold, the method comprises determining an anti-noise signal based on the at least one noise signal. And in response to the total signal level exceeding the signal level threshold, the method comprises determining a reduced anti-noise signal based on the at least one noise signal. The method further comprises forming a total playback signal and providing the total playback signal to the loudspeaker system for playback.

### CROSS-REFERENCE TO RELATED APPLICATION

This application claims the benefit and priority to European Patent Application No. EP25173967.8 filed May 2, 2025, which is incorporated herein by reference in its entirety.

### TECHNICAL FIELD OF THE INVENTION

The present disclosure relates to a method and system for performing active noise cancellation, especially performing active noise cancellation with reduced distortion for a wide variety of listening environments and noise levels.

### BACKGROUND OF THE INVENTION

Today, audio playback devices such as headphones or earphones are omnipresent, and most people use earphones or headphones on a daily basis. These playback devices can be brought along and used while traveling, e.g. commuting to and from work, which leads to them commonly being used in noisy environments such as in bustling city traffic, on airplanes or on trains.

To this end, earphones or headphones may be equipped with active noise cancellation (ANC) capability. For instance, since these devices are worn in immediate contact with a listener's ear, this enables active noise cancellation to be effectively employed to cancel out the environmental noise, such as the sound of traffic. Active noise cancellation is therefore commonly used in headphones and earphones to provide a more noiseless experience which for example makes the audio content played back by the headphones or earphones more intelligible and/or generally less obscured by noise.

In general, ANC works by recording a sample of the environmental noise and producing an anti-noise signal based on the noise sample. By outputting the anti-noise signal, e.g. by providing it to the loudspeaker emitting sound into the user's ear canal, destructive interference causes the unwanted noise to be cancelled completely or at least reduced. The anti-noise signal may be a phase-shifted version of the noise signal, e.g. the anti-noise signal is approximately 180 degrees out of phase (i.e. in anti-phase) with the noise signal.

Besides the anti-noise signal, playback devices are commonly configured to also emit an audio content signal the listener wants to enjoy, e.g. music, a podcast or the soundtrack of a movie etc. This audio content signal may be played back using the same loudspeaker system of the playback device as the anti-noise signal, enabling the earphones or headphones to be made more compact and less bulky compared to using multiple loudspeaker systems.

A drawback with existing active noise cancellation schemes is that in some circumstances, especially in very noisy environments and/or when the playback volume is high, the loudspeaker systems equipped with active noise cancellation fail to allow the listener to experience the audio content with a high quality of experience without distracting acoustic distortion. There is therefore a need for improving active noise cancellation to make it suitable for a wider range of environments and listening scenarios.

### SUMMARY

It is an object of the present invention to provide an improved listener experience for listeners using playback devices employing active noise cancellation. In particular, an improved listener experience with less acoustic distortions in very noisy environments is sought even when the listener is enjoying the audio content at a high volume. This and other objects are achieved by a method and system as defined by the independent claims.

A first aspect of the invention relates to a method for performing active noise cancellation for a loudspeaker system. The method comprises obtaining an audio content signal, obtaining at least one noise signal, and performing active noise suppression processing for each of at least one frequency band and for each noise signal. The active noise cancellation processing comprises determining, based on the audio content signal, an audio content signal level, determining, based on the at least one noise signal, a noise signal level and calculating a total signal level based on a combination of the audio content signal level and the noise signal level. The active noise cancellation further comprises obtaining a signal level threshold associated with the loudspeaker system and comparing the total signal level to the signal level threshold. In response to the total signal level being below the signal level threshold determining an anti-noise signal based on the at least one noise signal and in response to the total signal level exceeding the signal level threshold determining a reduced anti-noise signal based on the at least one noise signal. The method further comprises combining the anti-noise signal or reduced anti-noise signal of each frequency band and noise signal with the audio content signal to form a total playback signal and providing the total playback signal to the loudspeaker system for playback.

The loudspeaker system may be any type of loudspeaker system comprising at least one loudspeaker and at least one microphone for recording a noise signal. The loudspeaker system may e.g. be implemented in a set of headphones or earphones. With the term headphones or earphones it is meant any type of personal listening device such as earbuds, in-ear, on-ear or over-ear earphones or any type of hearable. The headphones or earphones may be wired or wireless. It is also envisaged that the loudspeaker system is an external loudspeaker system configured to output audio into an environment sized and adapted to house on or more listeners, such as a room or the interior space of a car.

When the loudspeaker system is a set of earphones or headphones the noise signal may be recorded in close proximity to the listener's ear canal or ear drum allowing the noise experienced by the listener to be sampled more accurately. In turn, this allows the anti-noise to be more effective for canceling the noise experienced by the listener.

In general, two or more noise signals may be used whereby the method comprises determining, for each of at least one frequency band of each noise signal a reduced anti-noise signal or (non-reduced) anti-noise signal. All anti-noise signals are combined together with the audio content signal to form the total playback signal.

The audio content signal may be any type of audio content signal such as a music signal, a podcast signal, the soundtrack of a movie or even a meditative white noise signal. The music content signal may be provided by a playback device (such as a smartphone, smartwatch, any type of portable media player or even a stationary Hi-Fi amplifier) to a playback device for playback, wherein the playback device implements the active noise cancellation method. The at least one noise signal and the audio content signal may be time-domain signals.

By considering the total signal level, and reducing the level of the anti-noise signal in response to the total signal level exceeding the signal level threshold, the playback quality of the audio content signal is prioritized over that of the anti-noise signal. That is, the audio content signal may be played back with reduced distortions compared to if the anti-noise signal is played back at the same time without reduction. While the reduced anti-noise signal may not be as effective for reducing noise as the original (non-reduced) anti-noise signal it has been realized that by proper tuning of the signal level threshold, the reduced anti-noise signal is used when the playback level of the audio content signal is high, whereby the reduced noise suppression may be not very noticeable or at least less noticeable compared to audio content signal distortions which otherwise could occur.

The signal level threshold may be associated with a signal level at which the loudspeaker system becomes saturated and/or enters the non-linear amplification region for the one or more frequency bands. The signal level threshold may be set with some margin from the signal level at which the loudspeaker saturates and/or enters the non-linear region. The signal level threshold may be static, e.g. associated with the specific loudspeaker of the headphones or earphones.

The first aspect of the invention achieves the above mentioned object by lowering the contribution of the anti-noise signal towards saturating loudspeaker of the loudspeaker system, when the total signal level reaches the signal level threshold. This is achieved through lowering the level of the anti-noise signal, i.e. forming a reduced anti-noise signal, in situations when outputting the original anti-noise signal and audio content signal together would risk saturating the loudspeaker system and thereby degrading the playback quality of both the anti-noise signal and audio content signal. Furthermore, since the total signal level is based on both the noise signal level and the audio content level, a higher level anti-noise signal is reduced more aggressively if the audio content level is higher. However, when the audio content signal level is high the need for anti-noise signals is presumed to be lower as the audio content is able to mask some noise whereby even though the anti-noise signal is reduced it has surprisingly been found that the listener may not perceive the reduction in anti-noise signal level and that the listener is expected to be more sensitive to distortions of the audio content signal which could be the result if the anti-noise signal level is not reduced.

In some embodiments, determining the reduced anti-noise signal further comprises obtaining a default ANC filter comprising a plurality of filter coefficients, modifying the default ANC filter to form a modified ANC filter based on the total signal level and processing the noise signal with the modified ANC filter to form the reduced anti-noise signal.

Anti-noise signals may be generated by a filter, referred to as an ANC filter. An ANC filter is configured to output an anti-noise signal for cancelling the noise-signal input to the ANC filter. Hereby, by modifying the coefficients of the ANC filter the level of the resulting anti-noise signal may be reduced. The ANC filter may be modified in different ways depending on what kind of filter it is. An ANC filter having its coefficients updated dynamically based at least in part on the total signal level may be referred to as a dynamic ANC filter.

When the total signal level is low, i.e. it is below the signal level threshold, the dynamic ANC filter may operate using default coefficients whereby the resulting anti-noise signal is not reduced. By modifying the filter coefficients when the total signal level exceeds the threshold the reduced anti-noise signal may be obtained efficiently. Modifying the filter coefficients may entail reducing the magnitude of at least a subset of the plurality of filter coefficients. Reducing the magnitude of filter coefficients may achieve a reduced anti-noise signal.

In some implementations, the modified ANC filter coefficients define a filter having a frequency response with a magnitude which is lower compared to that of the default ANC filter. The difference in magnitude for the frequency response between the modified and default ANC filter may vary as a function of frequency. For example, the decrease in frequency response magnitude at a first frequency may be higher compared to at a second and third frequency wherein the first frequency is higher than the second frequency and the third frequency is higher than the first frequency.

The ANC filter may be a recursive filter or non-recursive filter, more specifically an infinite impulse response (IIR) filter or finite impulse response (FIR) filter. These filter types are advantageous since the operate in the time domain and may respond quickly to changes in noise signal.

Additionally or alternatively to applying a dynamic ANC filter, determining the reduced anti-noise signal may comprise applying downward compression to the noise signal to form a reduced noise signal and determining the reduced anti-noise signal based on the reduced noise signal or applying downward compression to an anti-noise signal derived from the noise signal to form the reduced anti-noise signal. Wherein a downward compression gain of the downward compression is based on the total signal level.

Hereby, the reduced anti-noise signal may be determined by applying compression prior to, or after, the anti-noise signal has been generated based on the noise signal.

Determining the reduced anti-noise signal based on the reduced noise signal and determining the reduced anti-noise signal based on the anti-noise signal may comprise applying a default (static) ANC filter. Alternatively, the compressor may be combined with a dynamic ANC filter.

Compressing audio signals using a compressor is an efficient method for reducing the level of audio signals. By applying compression selectively based on the total signal level, the anti-noise signal level may be reduced, whereby loudspeaker saturation and the associated acoustic distortions may be avoided. Additionally, other operational parameters of the compressor, such as the compressor ratio, attack and release times etc. may be controlled based on the total signal level.

In some embodiments, the at least one frequency band is at least two frequency bands.

Hereby, the method of performing active noise cancellation is performed separately for different frequency bands. The at least two frequency bands may be two frequency bands, one low frequency band and one high frequency band, or more than two frequency bands such as one low frequency band, a high frequency band and one or more intermediate frequency bands. Performing noise suppression separately for different frequency bands is advantageous, since the noise level may be different in different frequency bands leading to different amounts of anti-noise signal reduction being required to avoid loudspeaker saturation and the associated acoustic distortions. For example, if the audio content signal and/or the anti-noise signal is of a very high level in a first frequency band, reduction of the anti-noise signal level may be implemented in the first frequency band. On the other hand, in a second frequency band the audio content signal and/or the anti-noise signal may be of a lower level whereby it is not necessary to reduce the anti-noise signal level in the second frequency band to avoid or mitigate distortions. That is, the total signal level, and if/how the anti-noise signal is to be reduced, may be determined on a per frequency band basis.

In some embodiments, the threshold signal level for a first frequency band may be different from the threshold signal level of a second frequency band. For Instance, it may be advantageous to set a lower signal level threshold for a first frequency band (which may be a lower frequency band) where it is more likely that the loudspeaker system creates unwanted distortion and a higher signal level threshold for a second frequency band (which may be a higher frequency band) where the loudspeaker system has more headroom and/or where distortion is less likely to happen. Hereby, in some implementations the signal level threshold of a second higher frequency band is higher compared to the signal level threshold of a first lower frequency band.

In some embodiments, the method further comprises obtaining acceleration data indicating a motion of the loudspeaker system and wherein determining the reduced anti-noise signal is further based on the acceleration data.

Acceleration data may be measured by an accelerometer or a pedometer or any other device capable of detecting movement of the listener and optionally provide an indication of how quickly the listener is moving. This is advantageous for embodiments wherein the loudspeaker system is implemented in a pair of earphones or headphones.

In some embodiments, determining the reduced anti-noise signal comprises processing the noise signal with an ANC filter or compressor and wherein a property of the ANC filter or compressor is controlled based on the acceleration data.

Upon detection of movement an attack and/or release time of the compressor may be decreased to let the reduced anti-noise signal change more rapidly. If the listener is listening to audio content while walking or running, the listener's steps may cause abrupt bursts of high level and by controlling the attack and/or release time of the compressor in this way, distortions caused by e.g. footsteps may be reduced.

Additionally or alternatively, the filter coefficients of the ANC filter may be replaced with an alternative set of filter coefficients in response to detecting movement so as to generate an anti-noise signal which is less bursty and less prone to cause saturation and introduce acoustic distortions.

Hereby, in some embodiments determining the reduced anti-noise signal comprises selecting a set of filter coefficients for an ANC filter from a group comprising at least two sets of filter coefficients based on the acceleration data.

For example, the alternative filter coefficients may be associated with a filter having a frequency response with less magnitude for a certain frequency range compared to the (default) filter coefficients of the ANC filter. The frequency range may be associated with noise from footsteps and may e.g. be below 100 Hz or below 80 Hz, such as between 1 Hz and 80 Hz. Hereby, upon detection of listener movement the alternative filter coefficients are used wherein the resulting anti-noise signal will be less prone to attempt to suppress the noise from footsteps and thereby less prone to push the loudspeaker system towards saturation and cause distortions. This may be especially useful for a feedback noise signal recorded close to the listener's ear canal whereby when the listener walks or runs, the earphones or headphones may move generally in phase with the listeners footsteps causing sound pressure peaks inside the listener's ear canal. These sound pressure peaks are generally difficult to suppress and if the ANC processor attempts to do so this risks introducing disruptive acoustic distortions. To avoid this, the ANC filter coefficients are modified to reduce the gain of the frequency response of the filter at low frequencies associated with footsteps.

In some embodiments, the loudspeaker system is provided in a set of earphones or headphones and wherein a feedback noise signal formed based on an audio signal recorded by a feedback microphone arranged to record the sound entering into the ear-canal of a listener, wherein the at least one noise signal comprises the feedback noise signal, and the method further comprises obtaining the feedback noise signal by subtracting the audio content from the audio signal recorded by the feedback microphone.

Advantages of using a feedback noise signal include that a noise signal recorded in the close proximity to the listener's eardrum will more accurately reflect the noise which is perceived by the listener. For example, compared to a feedforward noise signal sampled outside the ear canal and which typically is used with a static assumption of how the sampled noise alters when traversing from the outside to the inside of the headphone or earphone the feedback noise signal will sample the noise as closely as possible to how it is experienced by the listener. The feedforward noise signal may e.g. not consider the fact that the actual fit between the ear and the earphone may vary from one listener to another (which may affect how the noise traverses from the outside to the inside of the headphone or earphone) but this is not the case for the feedback noise signal which will sample the noise downstream of passing the headphone or earphone.

Since the feedback noise signal as recorded may be a mix of the audio content signal and the noise, determining the feedback noise signal may entail subtracting the audio content signal form the recorded feedback noise signal to leave substantially only the noise. Subtracting the audio content signal from the recorded feedback noise signal also inherently reduces the level of any anti-noise signals generated and helps avoid a situation wherein the anti-noise signal cancels the audio content signal.

More than one noise signal may be used and, in some embodiments, the at least one noise signal is at least two noise signals, the feedback noise signal and a feedforward noise signal recorded by a feed forward microphone arranged to record the sound of an external environment earphones or headphones.

The feedforward noise signal is not mixed with the audio content signal and offers an additional sampling of the noise the listener may experience. By using two or more noise signals recorded independently it is possible to improve the noise cancellation functionality.

The feedback noise signal will in general be usable for a limited band of lower frequencies to ensure stability. This is because the feedback noise signal is recorded close to the loudspeaker of the headphone or earphone which puts strict requirements on the associated ANC filter to avoid positive feedback loops. On the other hand, the feedforward noise signal may be usable within a broader frequency band compared to the feedback noise signal. Hereby, utilization of both noise signals leverages the advantages of both noise signals so as to enable improved noise suppression.

The feedforward noise signal may in some implementations be processed with an adaptive least mean squares (LMS) filter further enhancing the performance.

According to a second aspect of the invention there is provided an active noise cancellation processor, comprising a processor and memory, wherein the processor is configured to perform the method according to the first aspect.

According to a third aspect of the invention there is provided a computer program product comprising instructions which, when the program is executed by a computer, cause the computer to carry out the method according to the first aspect.

The invention according to the second and third aspect features the same or equivalent benefits as the invention according to the first aspect. Any functions described in relation to the method may have corresponding features in an ANC processor or a computer program product.

### BRIEF DESCRIPTION OF THE DRAWINGS

Embodiments of the present invention will be described in more detail with reference to the appended drawings.

FIG. 1 is a block diagram illustrating a playback device with an active noise cancellation processor and a loudspeaker system according to some embodiments.

FIG. 2 is a block diagram illustrating a compressor according to some embodiments.

FIG. 3 is a block diagram illustrating a playback device with an active noise cancellation processing operating with a plurality of frequency bands, according to some embodiments.

FIG. 4 is a block diagram illustrating a playback device with an active noise cancellation processor operating in multiple frequency bands with an adjustable ANC filter operating in each frequency band according to some embodiments.

FIG. 5 is a flowchart describing a method for performing active noise cancellation according to some embodiments.

FIG. 6 is a graph illustrating the frequency response of a dynamic ANC filter operating with default filter coefficients and modified filter coefficients, according to some embodiments.

### DETAILED DESCRIPTION

In the following detailed description, preferred embodiments of the invention will be described. However, it is to be understood that features of the different embodiments are exchangeable between the embodiments and may be combined in different ways, unless anything else is specifically indicated. Any module of a playback device or active noise cancellation processor may be implemented as hardware or software and may have a corresponding step in a method.

In general, active noise cancellation (ANC) works through recording environmental noise, generating an anti-noise signal based on the environmental noise and emitting the anti-noise signal into the listening environment for cancellation, or at least suppression, of the environmental noise through destructive interference. In a simple embodiment, the anti-noise signal is an anti-phase version of a recorded noise signal. Active noise cancellation may be performed by different types of devices in different environments. For example, active noise cancellation may be performed by an ANC processor of a set of headphones or earphones while at the same time audio content (such as music or speech) is played back, allowing the listener to enjoy the audio content with less disturbance from the environmental noise.

A playback device (such as a set of earphones or headphones) configured to perform ANC may therefore comprise at least one electro acoustic converter, e.g. a microphone for recording a noise signal, a loudspeaker and an ANC processor configured to produce an anti-noise signal based on the recorded noise signal. The playback device may further comprise a receiver configured to receive an audio content signal to be played back by a loudspeaker system together with the anti-noise signal.

Aspects of the current invention relate to methods and systems for performing active noise cancellation for a playback device, such as headphones or earphones.

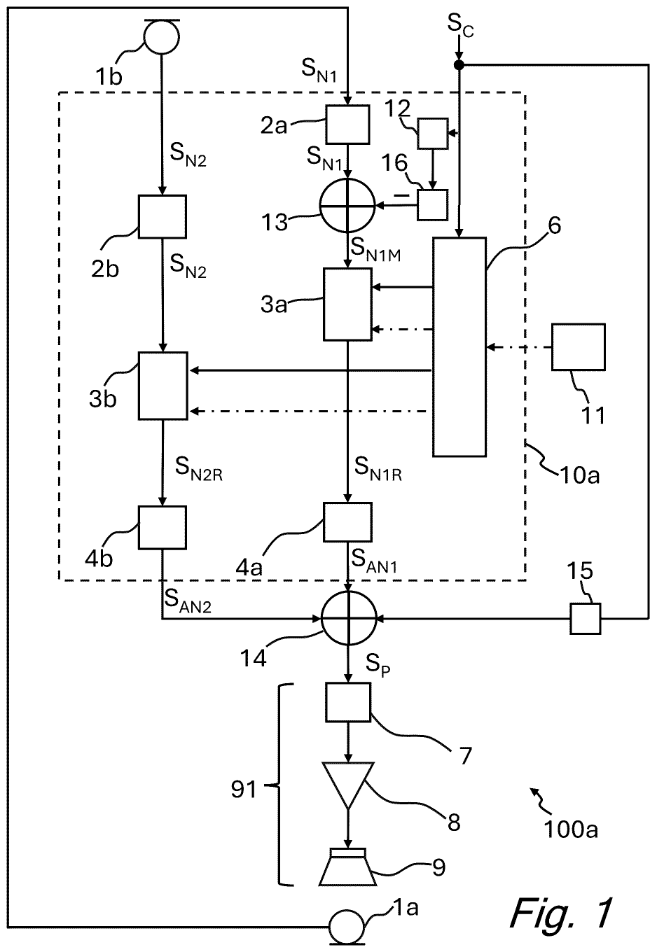

FIG. 1 is a block diagram illustrating an exemplary playback device 100a comprising an ANC processor 10a and a loudspeaker system 91.

The ANC processor 10a obtains an audio content signal SC and an at least one noise signal SN1, SN2.

The audio content signal may be obtained in a number of ways, as will be appreciated by the person skilled in the art. For instance, the audio content signal may be obtained over a wireless or wired connection, such as over a Bluetooth connection. The audio content signal SC is routed to be output by a loudspeaker 9 of the loudspeaker system 91, as described below. The audio content signal SC is further used in the generation of one or more an anti-noise signal SAN1, SAN2 by the ANC processor 10a, whereby the audio content signal SC may also be provided to the ANC processor 10a.

There are also multiple ways of obtaining the at least one noise signal SN1, SN2. For active noise cancellation to be performed, it is sufficient that one noise signal SN1, SN2 is obtained so that a corresponding anti-noise signal SAN1, SAN2 may be generated. However, two or more noise signals, SN1, SN2 may be used in parallel to improve the noise cancellation performance.

A first noise signal SN1 (also referred to as a feedback noise signal) may be recorded by a feedback microphone 1a arranged so as to record the noise in close proximity to the where the listener will be located to perceive the noise. When the playback device 100a is a set of earphones or headphones, the feedback microphone 1a may be located close to the listener's eardrum or ear-canal whereby it picks up a mix of the both the noise and the audio content signal SC played back by the loudspeaker 9. A first anti-noise signal SAN1 may be generated by the ANC processor 10a based on the first noise signal SN1.

A second noise signal SN2 (also referred to as a feedforward noise signal) may be recorded by a feedforward microphone 1b arranged to record the noise of the listening environment. If the playback device 100a is a set of earphones or headphones the feedforward microphone 1b may be arranged on an exterior surface of the earphones or headphones so as to record the noise of the environment of the listener. A second anti-noise signal SAN2 may then be generated from the second noise signal SN2.

The first noise signal SN1 may offer a more accurate representation of the noise perceived by the listener whereas the second noise signal SN2 samples the noise which must first propagate through the earphone or headphone prior to being perceived by the listener, and the noise which reaches the listener's eardrum may in general depend on e.g. the fit of the headphones or earphones to the listener's ear. On the other hand, the first noise signal SN1 may be disrupted by the audio content signal SC which is played back by the loudspeaker 9 (which also is located in close proximity to the listener's eardrum or ear-canal) whereas the second noise signal SN2 may be substantially free from disruptive audio content.

Either or both of the first and second noise signal SN1, SN2 may be used by the ANC processor 10a to form anti-noise signals SAN1, SAN2 as will now be described. The embodiment of FIG. 1 utilizes both the first noise signal SN1 recorded by the feedback microphone 1a and the second noise signal SN2 recorded by the feedforward microphone 1b but embodiments wherein only one of the microphones 1a, 1b is present are envisaged.

In the ANC processor 10a of FIG. 1, the first and second one noise signal SN1, SN2 are first processed by a respective analog-to-digital converter module 2a, 2b which converts each noise signal SN1, SN2 from analog to digital. This enables the subsequent modules of the ANC processor 10a to operate on digital signals. The audio content signal SC may also be a digital signal. In some embodiments, the first and/or second noise signal SN1, SN2 are band-limited to a frequency band. For example, the first and/or second noise signal SN1, SN2 are band-limited to a frequency band spanning 10 Hz to 10 kHz. Band limitations may be achieved using first or second order filters.

As described above, the first noise signal SN1 recorded close to the where the listener will experience the audio content (e.g. inside the ear canal of the listener) may comprise a mix of the audio content signal SC as well as the environmental noise. To generate an anti-noise signal SAN1 based on the first noise signal SN1, the audio content signal SC may be subtracted from the first noise signal SN1 at summation module 13. By subtracting the audio content signal SC from the first noise signal SN1 the output from the summation module 13, referred to as a modified first noise signal S_{N1M}, may substantially only contain environmental noise without interference from the audio content signal S_{C}.

The audio content signal S_{C} input to the summation module 13 may first pass a delay module 12 configured to delay the audio content signal S_{C} with a predetermined time delay. With the delay module 12 (and delay module 15) it is possible to add a delay between the audio content signal S_{C} that reaches the loudspeaker system 91 and the audio content signal S_{C} that is analyzed in the controller module 6 to allow for lookahead analysis of the audio content signal S_{C}.

The audio content signal S_{C} may further pass an audio subtraction filter module 16 prior to being provided to summation module 13. The audio subtraction filter module 16 models a transfer function from the input to the loudspeaker system 91 to the output of the feedback microphone 1a. This enables proper subtraction of the part of the audio content signal S_{C} which is expected to reach the feedback microphone 1a from the noise signal S_{N1}. By comparison, without the audio subtraction filter module 16 the subtraction at summation module 13 may be too aggressive, which could result in a modified first noise signal S_{N1M} which less accurately captures the noise.

In general, there is no need to subtract the audio content signal SC from the second noise signal SN2, as the second noise signal was recorded by the feedforward microphone 1b which is not expected to be disturbed by the audio content signal SC played by the loudspeaker 9.

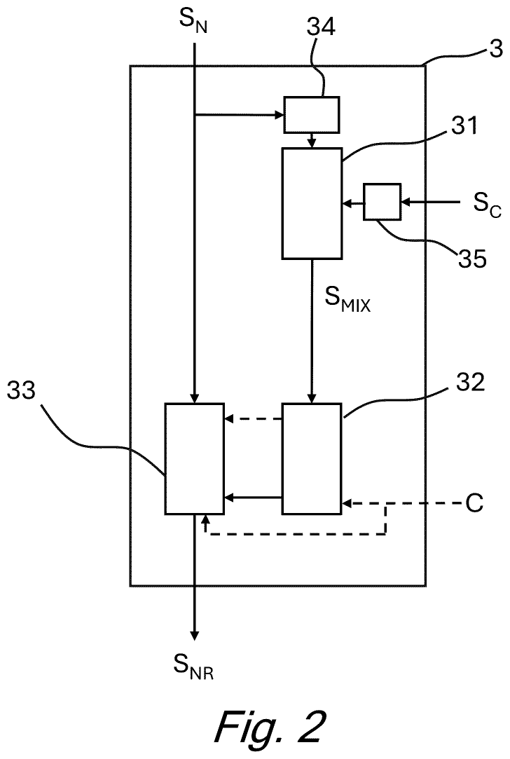

The modified first noise signal SN1M and the second noise signal SN2 are provided to a respective compressor module 3a, 3b. The compressor module 3a, 3b is described in further detail in connection with FIG. 2. In general, each compressor module 3a, 3b is configured to compress the modified first noise signal SN1M or the second noise signal SN2 to form a first reduced noise signal SN1R and a second reduced noise signal SN2R.

Each compressor module 3a, 3b is configured to compress its respective received noise signals SN1M, SN2, such that the level of the noise signal SN1, SN2 is reduced, in response to the signal level threshold being exceeded.

That is, if and when compression is to be applied and which amount of compression that should be applied by each compressor module 3a, 3b is based on a combination of a level of the audio content signal SC and a level of the respective noise signal SN1, SN2 i.e. the total signal level. In general, compressor modules 3a, 3b are configured to apply compression when the total signal exceeds a signal level threshold. The signal level threshold may be associated with the non-linear region of the loudspeaker system 91. If and to what extent the compressor module(s) 3a, 3b apply compression may be signed by the controller module 6 which provides control data and/or a sidechain signal based on the audio content signal SC to each compressor module 3a, 3b.

Any loudspeaker system 91 is limited in terms of the total signal level it is able to output without distortion. When a loudspeaker system 91 is put under stress by playing back a high signal level it eventually saturates and reaches its maximum output level. Prior to reaching saturation, the loudspeaker system 91 enters the non-linear region wherein audio signals become distorted leading to disruptive acoustic distortions and introduction of higher order harmonics. The loudspeaker system 91 comprises a loudspeaker 9 and may further comprise an amplifier 8 and digital to analogue converter 7. The distortion brought by high signal levels of the playback signal may be introduced by anyone of the amplifier 8, the digital to analogue converter 7 and the loudspeaker 9.

Thus, when the playback device 100a is used in environments with very loud noise and/or when the audio content signal SC is played back with a high signal, the loudspeaker system 91 risks entering the non-linear region. To avoid this, the signal level of the noise-signals SN1, SN2 are reduced by the compressor modules 3a, 3b when the total signal level exceeds the signal level threshold. While compression of the noise signals may entail deviating from outputting the original or “full” ant-noise signals it has been found that it is preferable to avoid saturation over performing full noise cancellation. For example, in many scenarios and especially when the environmental noise is very loud, the audio content signal SC is played back with sufficient level to mask the noise. Additionally, if the non-linear region or saturation is not actively avoided the associated distortions affect both the anti-noise signals and the audio content in a negative way, but with the ANC processor 10a of FIG. 1 distortion of the audio content signal SC is mitigated by deliberate reduction of the anti-noise signals. In other words, the audio content signal SC is prioritized over the anti-noise signals in scenarios where playback of both signals at the same time would cause the loudspeaker system 91 to enter the non-linear region.

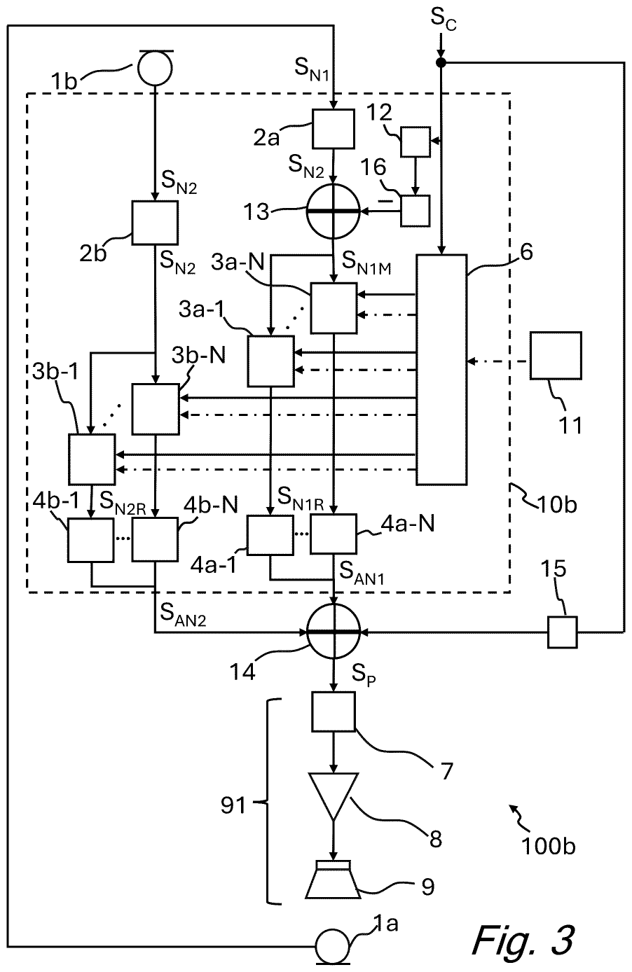

FIG. 2 is a block diagram illustrating a compressor module 3 according to some embodiments. For example, compressor module 3a, 3b of FIGS. 1 and 3 may correspond to the compressor module 3 of FIG. 2.

The compressor module 3 obtains a noise signal SN (such as the first or second noise signal SN1, SN2) and outputs a reduced noise signal SNR. In some situations compression is deactivated since the total signal level does not exceed the signal level threshold. In such situations SN may be equal to SNR.

The noise signal SN is provided to a weighting mixer module 31 alongside the audio content signal SC (or a filtered version thereof) which may be referred to as a sidechain signal. The weighting mixer module 31 mixes the noise signal SN and the audio content signal SC to form a mixed audio signal SMIX. The mixed audio signal SMIX, being a combination of both the noise signal SN and the audio content signal SC, may represent the total signal level. The compressor module 3, may comprise filter blocks 34, 35 for filtering a respective one of SN and SC prior to these being input to the mixer module 31. For example, filter blocks 34, 35 may amplify or attenuate certain frequencies of these signals before the mixing. This is beneficial if certain frequency areas need to be treated differently because the likelihood of distortion is bigger in these frequency areas. For example, if a frequency band of the SC signal is amplified by filter block 35 the reduction of the noise signal will be more aggressive in this frequency band.

The weighting mixer module 31 may be associated with a weighting parameter indicating a relative weighting of the audio content signal SC relative to the noise signal SN. Hereby, the weighting parameter determines a priority between the audio content signal SC and the noise signal SN. A higher weighting parameter for the audio content signal SC may entail that the audio content signal SC is mixed with a higher level compared to the noise signal SN which will lead to the noise signal SN being compressed more aggressively to avoid non-linearity related distortions. On the other hand, a lower weighting parameter may entail that the audio content signal SC is mixed with a lower level compared to the noise signal SN which will lead to the noise signal SN being compressed less aggressively.

The mixed audio signal SMIX is provided to a level analyzer module 32 configured to determine if, and to what extent, the SMIX audio signal exceeds the signal level threshold. The signal level threshold may be provided by the controller module 6 (see FIG. 1) and provided in a control signal C or stored locally in the level analyzer module 32. The level analyzer module 32 may determine a root mean square (RMS) or peak level of the mixed audio signal SMIX and determine if, and optionally to what extent the level exceeds the audio signal threshold.

The level analyzer module 32 may determine the maximum level of the mixed audio signal SMIX in a context window and this maximum level corresponds to the total signal level. The context window may comprise look-back samples and optionally look-ahead samples. In some implementations the level analyzer module 32 has a context window associated with a response time of between 100 microseconds to a few milliseconds. For higher frequencies, a shorter response time is preferred and for lower frequencies a longer response time may be used.

The level analyzer module 32 controls an attenuation module 33 configured to apply a compression gain (i.e. an attenuating gain) to the noise signal SN based on a control signal from the level analyzer module 32 to form an output reduced noise signal SNR. In response to the level analyzer module 32 determining that the level of the mixed audio signal SMIX (i.e. the total signal level) does not exceed the threshold, the attenuation module 33 is controlled to not apply any compression gain (or equivalently apply a gain of 0 dB). In response to the peaks analyzer module 32 determining that the total signal level of the mixed audio signal SMIX exceeds the threshold, the attenuation module 33 is controlled to apply a compression gain based on the total signal level. For example, the attenuating gain is proportional to the total signal level whereby a greater compression is applied for greater total signal level and vice versa. The attenuation module 33 may apply compression with an attack time, release time, compressor ratio, compressor threshold and other compressor parameters. One or more of these parameters may be adjusted e.g. based on a control signal C from the controller module 6.

The output from the attenuation module 33 is a reduced noise signal SNR or (when the signal level threshold is not exceeded) the noise signal SN.

Embodiments are also envisaged wherein the weighting mixer module 31 and the level analyzer module 32 are omitted, and the attenuation module 33 is controlled directly by the controller module 6 indicating one or more of the compressor attenuation, threshold, the compressor ratio and the attack and/or release time in a control signal C provided by a controller module. For example, these parameters are based on the total signal level or acceleration data, as described below.

Turning back to FIG. 1, the ANC processor 10a comprises a controller module 6. The controller module 6 may in some embodiments be configured to determine at least one compressor parameter such as a compressor threshold, an attack and/or release time or a compressor ratio for the compressor 3a, 3b. The attack and/or release time, threshold, or any other compressor parameters may be varied based on acceleration data from an acceleration tracker 11 as described below.

The controller module 6 may determine the compressor attack/release times based on the content signal SC characteristics. The controller module 6 may be configured to implement some lookahead when determining the attack and/or release time, compressor ratio and/or compressor threshold. For example, by introducing a predetermined delay in the audio content signal SC path using delay modules 12, 15 it is possible for the controller module 6 to operate with a predetermined amount of lookahead, enabling the controller module 6 to detect transients in the audio content signal SC ahead of time. The predetermined delay may be between a millisecond up to several hundred milliseconds which results in the same amount of lookahead. The controller module 6 may be configured to adjust one or more compressor parameters to smoothly approach a target set of compressor parameters based on the lookahead. For example, if a rapid increase in audio content signal level is detected, the controller module 6 may smoothly increase the compressor ratio or smoothly decrease the attack time over time to avoid distortions in the audio content signal when the rapid level increase occurs.

The compressor parameters may be provided to the attenuation module 33 and used to control the gain reduction module dynamically. Hereby, embodiments of the compressors without the weighting mixer module 31 and the peaks analyzer module 32 are envisaged wherein the controller 6 controls the attenuation module 33 directly at least partially based on the total signal level with respect to the signal level threshold.

The compressed noise signals output by each compressor 3a, 3b are provided to a respective ANC filter 4a, 4b. Each ANC filter 4a, 4b is configured to generate an anti-noise signal SAN1, SAN2 based on the noise signal. The ANC filters 4a, 4b may be an infinite impulse response filter (IIR) or a finite impulse response filter (FIR). A purpose of the ANC filters 4a, 4b is to phase shift the noise signal 180 degrees, ensure stability and modify the frequency response such that an anti-noise signal SAN1, SAN2 is generated which is in anti-phase with the input (modified) noise signal. When the compressor(s) 3a, 3b are used, the ANC filter(s) 4a, 4b may be static, default, ANC filter(s) 4a, 4b. It is also envisaged that the ANC filter(s) 4a, 4b may be dynamic ANC filter(s) as described below. Furthermore, a combination with at least one dynamic ANC filter is also possible, for example implemented parallel or serial configuration.

The anti-noise signals SAN1, S_{AN2} are provided to summation module 14 alongside the audio content signal S_{C}, whereby the anti-noise signals S_{AN1}, S_{AN2} are combined with the audio content signal S_{C} to form a total playback signal S_{P}. The total playback signal S_{P} may be provided to the loudspeaker system 91 for playback. The loudspeaker system 91 comprises a digital to analogue converter module 7 and an amplifier 8 and the loudspeaker 9.

As mentioned above, utilization of both the first and second noise signal S_{N1}, S_{N2} is merely exemplary and embodiments are envisaged wherein only one of the first and second noise signal S_{N1}, S_{N2} is utilized. In such embodiments, the modules associated with the other one of the first and second noise signal may be omitted.

Additionally, in the embodiment of FIG. 1, the compressors 3a, 3b are arranged upstream of the ANC filters 4a, 4b however this is also exemplary. It is envisaged that the one or both of the compressors 3a, 3b may be arranged downstream from the ANC filters 4a, 4b and operate on anti-noise signals instead of noise signals in the corresponding manner so as to form reduced anti-noise signals based on input anti-noise signals.

FIG. 3 is a block diagram illustrating a playback device 100b comprising an ANC processor 10b operating on multiple frequency bands. The ANC processor 10b comprises modules corresponding to the equivalent modules in FIG. 1. A difference between the ANC processor 10b of FIG. 3 and the ANC processor 10a of FIG. 1 is that the ANC processor 10b applies an individual compression to each of a plurality of frequency bands for each noise signal SN1, SN2.

The first and second noise signal SN1, SN2 are divided into a set of N≥2 frequency bands. The N frequency bands may be non-overlapping. For example, the N frequency bands are obtained by processing each of the modified first noise signal SN1M and the second noise signal with N filters (not shown). As an illustrative example, when N=3 the three filters may comprise a low pass filter with a cutoff frequency of f1, a bandpass filter with cutoff frequencies f2 and f3 and a high pass filter with cutoff frequency f4 wherein f1≤f2<f3≤f4.

Each frequency band of each noise signal SN1M, SN2 is processed individually by a respective compressor 3a-1, . . . 3a-N, 3b-1, . . . 3b-N and a respective ANC filter 4a-1, . . . 4a-N, 4b-1, . . . 4b-N so as to form, for each noise signal, N (selectively reduced) anti-noise signals. The N selectively reduced anti-noise signals are combined prior to being provided to summation module 14 for combination with the audio content signal SC.

In some implementations, it is envisaged that the output of each compressor 3a-1, . . . 3a-N, 3b-1, . . . 3b-N is combined prior to processing with ANC filters, whereby a single ANC filter may be used for each noise signal. An advantage of such implementations is that the number of computational operations is reduced.

An advantage of the ANC processor 10b of FIG. 3 is that the compression of the noise signals SN1M, SN2 is applied for each of the N frequency bands individually. This may e.g. alleviate anti-noise level reduction in a first frequency band, if the noise and/or audio content signal is concentrated to a different second frequency band.

In some scenarios, the signal level threshold is frequency band specific. For example, the loudspeaker system 91 may enter saturation for lower frequencies at lower signal levels compared to for higher frequencies, whereby the audio signal threshold may be lower for a lower frequency band and higher for a higher frequency band.

For Instance, it may be advantageous to set a lower signal level threshold for a first (lower) frequency band where it is more likely that the loudspeaker system 91 creates unwanted distortion and set a higher signal level threshold for another (higher) frequency band where the loudspeaker system 91 has more headroom and distortion is less likely. As for the embodiment of FIG. 3, it is also envisaged here that only one of the two noise signals SN1M, SN2 may be used and/or that the compressors 3a-1, . . . 3a-N, 3b-1, . . . 3b-N may be arranged upstream or downstream of the ANC filters 4a-1, . . . 4a-N, 4b-1, . . . 4b-N.

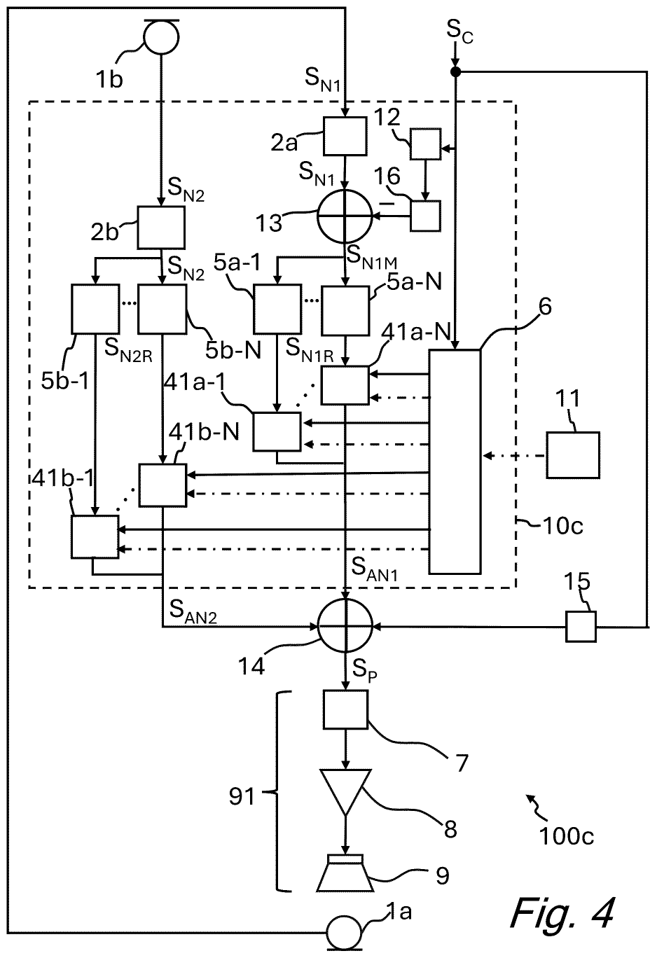

FIG. 4 illustrates a playback device 100c comprising an ANC processor 10c according to some embodiments. Like the ANC processor 10b of FIG. 3, the ANC processor 10c processes the noise signals SN1M, SN2 individually in multiple frequency bands. A difference between the ANC processor 10c and the ANC processor 10b is that the ANC processor 10c comprises, for each frequency band and each noise signal, a signal level analyser 5a-1, . . . 5a-N, 5b-1, . . . 5b-N and a dynamic ANC filter 41a-1, . . . 41a-N, 41b-1 . . . 41b-N.

The processing performed in a first frequency band for the modified first noise SN1M signal will now be described in detail. However, it will be appreciated that the analogous process is performed for each frequency band of each noise signal.

The modified first noise signal SN1M of the first frequency band is provided to a level detector module 5a-1. The level detector module 5a-1 is configured to determine a noise level of the modified first noise signal SN1M and provide information indicating the noise level to the controller module 6. The controller module 6 also obtains the audio content signal SC and determines an audio content level of the audio content signal SC. Using the audio content level and the noise level the controller module 6 determines a total signal level and compares the total signal level to the signal level threshold. Based on the comparison, the controller module 6 determines a set of filter coefficients for the dynamic ANC filter 41a-1. The filter coefficients are then applied by the dynamic ANC filter 41a-1.

The filter coefficients for the dynamic ANC filter 41a-1 may be determined in variety of ways.

In some embodiments, in response to the total signal level being below the signal level threshold the filter coefficients are kept at predetermined default values.

In response to the total signal level exceeding the signal level threshold the default filter coefficients may be scaled with a scaling factor. The scaling factor may be based on the total signal level wherein the scaling factor is inversely proportional to the total signal level. For example, if the total signal level increases, the scaling factor decreases, so as to reduce the ANC filter magnitude and thereby form a reduced anti-noise signal.

In some embodiments, in response to the total signal level exceeding the threshold associated with saturation the default filter coefficients may be replaced with a predetermined alternative set of filter coefficients, the alternative set being configured to generate a lower magnitude anti-noise signal. More than one alternative set of filter coefficients may be available to the controller module 6, allowing the controller module 6 to provide filter coefficients for generating progressively lower magnitude anti-noise signals as the total signal level increases.

As an example, an IIR filter may be defined as

y[n]=b₀x[n]+. . . +b_{P}x[n−P]+a₁y[n−1]+. . . +a_{Q}y[n−Q]# (1)

Wherein x[n] is the input signal of signal sample index n, y[n] is the output signal of the IIR filter at signal sample n and bᵢ and aⱼ are the filter coefficients.

As seen in equation 1 by reducing at least some, possibly all, filter coefficients bᵢ and aⱼ in the IIR, the resulting anti-noise signal, i.e. y[n] gets a reduced signal level which may help alleviate the problem of non-linear distortions.

In some implementations, the default ANC filter coefficients are replaced with modified filter coefficients in response to the signal threshold level being exceeded, wherein the modified filter coefficients define a filter having a frequency response magnitude which is lower at one or more frequencies compared to the default ANC filter. For example, the decrease in frequency response magnitude from the default ANC filter to the modified ANC filter at a first frequency may be greater compared to at a second and third frequency wherein the first frequency is higher than the second frequency and the third frequency is higher than the first frequency. For example, the first frequency is in the range of 70 Hz to 130 Hz, the second frequency is below 70 Hz, and the third frequency is between 130 Hz and 2 kHz.

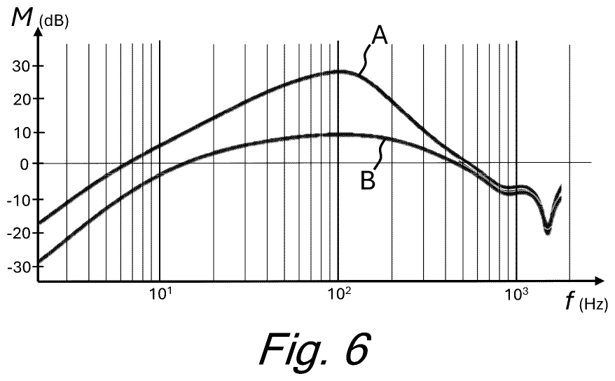

The frequency response magnitude of one exemplary default ANC filter and one exemplary modified ANC filter are shown in FIG. 6. The magnitude (in decibels) of the frequency response for the default ANC filter is illustrated with graph A and the magnitude of the frequency response for the modified ANC filter is illustrated with graph B. As can be seen, the magnitude decreases with an amount varying with frequency and the greatest magnitude reduction is at around 100 Hz with the magnitude reduction decreasing as the frequency increases or decreases from around 100 Hz.

While FIG. 4 operates using a plurality of N frequency bands it is noted that the dynamic ANC filters may be used for a single frequency band as well.

Accordingly, a reduced anti-noise signal may be obtained in a variety of ways. The reduced anti-noise signal may be obtained using a compressor operating on the noise signal and/or on an anti-noise signal obtained from the noise signal as described in connection with FIGS. 1-3. The reduced anti-noise signal may be obtained by selectively controlling the filter coefficients of a dynamic ANC filter as described in connection with FIG. 4. The two approaches may also be combined, and it is envisaged that a dynamic ANC filter module may be combined with a compressor module wherein both modules cooperate to form a reduced anti-noise signal.

A benefit with the ANC processors 10a, 10b and 10c is that noise signals and audio content signals may remain as time-domain signals, and it is not necessary for any audio signal to be transformed into the frequency domain using e.g. an FFT. This allows the ANC processor to respond rapidly to changes in noise level and audio content signal level whereby the resulting anti-noise signals result in improved noise suppression.

In any of the embodiments described in connection with FIGS. 1-4 the controller module 6 may be further configured to obtain acceleration data from an acceleration tracker 11. The acceleration tracker 11 may be provided separately and/or may be integrated in the headphones or earphones. The acceleration tracker 11 may comprise an accelerometer configured to measure an acceleration of the listener and indicate, using the acceleration data, to the controller module 6 if the listener is moving or stationary. The acceleration data may indicate a level of acceleration, on a scale from 0 to 1 wherein 0 indicates a perfectly still listener and 1 indicates a listener which moves rapidly (e.g. a listener which is running). Based on the acceleration data the controller module 6 is configured to control various aspects of the compressor or dynamic ANC filter.

In some embodiments, the controller module 6 adjusts an attack and/or release time of the gain reduction module 33 in the compressor based on the acceleration data. For example, if the acceleration data indicates that the listener is moving the attack and/or release time are shortened so as to more rapidly respond to changes in noise. This may be beneficial when the listener is walking, wherein the abrupt sounds made by footsteps may lead to distracting acoustic distortions if the compression does not respond sufficiently quick. On the other hand, when the listener is stationary the environmental noise is expected to be more constant over time wherein a longer attack and/or release time may be used to more smoothly adjust the compression.

In some embodiments, the controller module 6 selects less aggressive or less sensitive filter coefficients for the dynamic ANC filters when the listener is moving. This may result in the resulting anti-noise signals being substantially free from rapid transients which otherwise may introduce distortions.

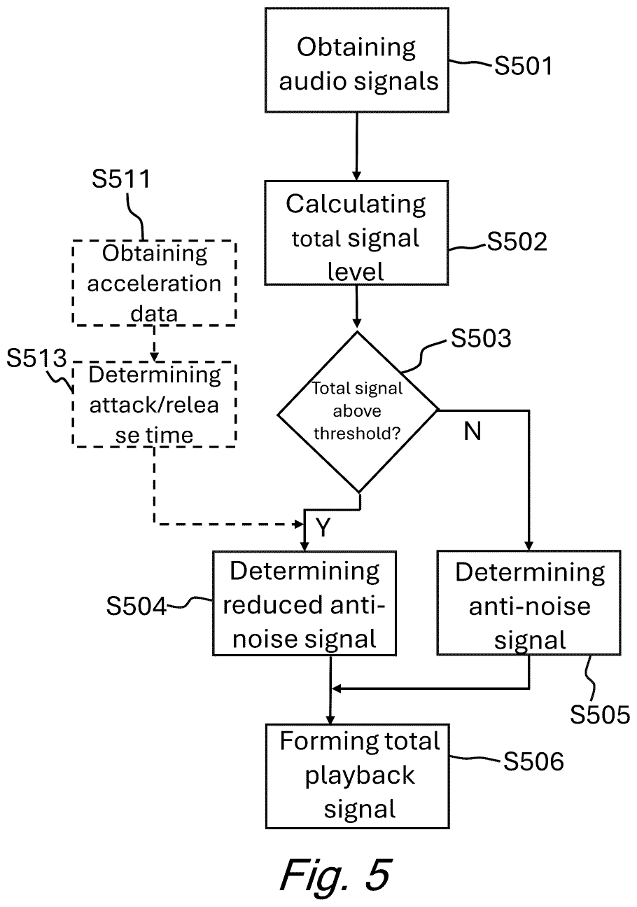

FIG. 5 is a flowchart illustrating a method for performing ANC processing according to some embodiments, the method may e.g. be performed by any of the ANC processors described above.

At step S501 an audio content signal SC and at least one noise signal SN1M, SN2 are obtained. For example, the noise signal is the modified first noise signal SN1M described above. The method then goes to step S502 comprising calculating, for each frequency band and for each noise signal, a total signal level. The total signal level is e.g. obtained by mixing a noise signal with the audio content signal. Additionally, or alternatively, the total signal level is determined using a signal level analyser module.

At step S503 it is determined if the total signal level is above the audio signal threshold. The signal level threshold is associated with a level required for the loudspeaker system to enter into the non-linear region associated with saturation and may be the same for all frequency bands (in embodiments with two or more frequency bands) or it may be set different for each frequency band.

If it is determined at step S503 that the total signal level exceeds the signal level threshold, the method goes to step S504 comprising determining a reduced anti-noise signal. The reduced anti-noise signal may be obtained by applying compression to one of the at least one noise signal (i.e. applying compression upstream of the ANC filter) or to the anti-noise signal (i.e. applying compression downstream of the ANC filter). The reduced anti-noise signal may be obtained by processing the noise signal with a dynamic ANC filter with non-default ANC filter coefficients.

If it is determined at step S503 that the total signal level does not exceed the signal level threshold associated with saturation, the method goes instead to step S505 comprising determining a (non-reduced) anti-noise signal. For example, the anti-noise signal is obtained using a default ANC filter and/or the compressor does not apply a compressing gain.

The method then goes to step S506 comprising forming a total playback signal by combining the one or more reduced (or non-reduced) noise signals and the audio content signal. The total playback signal may e.g. be provided to a loudspeaker system for playback.

Optionally, the method comprises step S511 comprising obtaining acceleration data indicating if the listener is moving. For example, the acceleration data is obtained from an acceleration tracker 11. The method then goes to step S513 comprising, determining, based on the acceleration data an attack and/or release time. The attack and/or release time may then be utilized at step S504 when the reduced anti-noise signal is determined using a compressor. For example, if the listener is moving, the attack and/or release time is reduced to provide a more rapid response to changes in noise. In embodiments applying a dynamic ANC filter in addition to or instead of the compressor, the acceleration data may instead be used to select ANC filter coefficients for a less aggressive filter.

The person skilled in the art realizes that the present invention by no means is limited to the preferred embodiments described above. On the contrary, many modifications and variations are possible within the scope of the appended claims. For example, the compressor and dynamic ANC filter may be used separately or together and the ANC processors described herein may operate with a single frequency band or with multiple frequency bands.

1. A method for performing active noise cancellation for a loudspeaker system, comprising:
obtaining an audio content signal;
obtaining at least one noise signal;
performing active noise suppression processing for each of at least one frequency band and for each noise signal, the active noise cancellation processing comprising:
determining, based on the audio content signal, an audio content signal level;
determining, based on the at least one noise signal, a noise signal level;
calculating a total signal level based on a combination of the audio content signal level and the noise signal level;
obtaining a signal level threshold associated with the loudspeaker system;
comparing the total signal level to the signal level threshold;
in response to the total signal level being below the signal level threshold:
determining an anti-noise signal based on the at least one noise signal;
in response to the total signal level exceeding the signal level threshold:
determining a reduced anti-noise signal based on the at least one noise signal;
the method further comprising:
combining the anti-noise signal or reduced anti-noise signal of each frequency band and noise signal with the audio content signal to form a total playback signal; and
providing the total playback signal to the loudspeaker system for playback.

2. The method according to claim 1, wherein determining the reduced anti-noise signal comprises:
obtaining a default ANC filter comprising a plurality of filter coefficients;
modifying the default ANC filter to form a modified ANC filter based on the total signal level; and
processing the noise signal with the modified ANC filter to form the reduced anti-noise signal.

3. The method according to claim 1, wherein modifying the default ANC filter comprises changing at least a subset of the plurality of filter coefficients.

4. The method according to claim 1, wherein the ANC filter is a recursive filter, such as an infinite impulse response, IIR, filter or finite impulse response, FIR, filter.

5. The method according to claim 3, wherein changing at least a subset of the plurality of filter coefficients comprises changing the plurality of filter coefficients such that the magnitude of the frequency response of the modified ANC filter decreases with respect to the default ANC filter, wherein the decrease in magnitude varies as function of frequency.

6. The method according to claim 1, wherein the loudspeaker system is provided in a set of earphones or headphones and wherein the at least one noise signal comprises a feedback noise signal formed based on an audio signal recorded by a feedback microphone arranged to record the sound entering into the ear-canal of a listener, and wherein the method further comprises obtaining the feedback noise signal by subtracting the audio content signal from the audio signal recorded by the feedback microphone.

7. The method according to claim 6, wherein the at least one noise signal is at least two noise signals, the feedback noise signal and a feedforward noise signal recorded by a feed forward microphone arranged to record the sound of an external environment of the earphones or headphones.

8. The method according to claim 1, wherein determining the reduced anti-noise signal comprises:
applying downward compression to the noise signal to form a reduced noise signal and determining the reduced anti-noise signal based on the reduced noise signal; or
applying downward compression to an anti-noise signal derived from the noise signal to form the reduced anti-noise signal; and
wherein a downward compression gain of the downward compression is based on the total signal level.

9. The method according to claim 1, wherein the at least one frequency band is at least two frequency bands.

10. The method according to claim 1, wherein the signal level threshold is associated with a signal level at which the loudspeaker system becomes saturated for the frequency band.

11. The method according to claim 1, further comprising:
obtaining acceleration data indicating a motion of the loudspeaker system;
wherein determining the reduced anti-noise signal is further based on the acceleration data.

12. The method according to claim 11, wherein determining the reduced anti-noise signal comprises processing the noise signal with an ANC filter or compressor and wherein a property of the ANC filter or compressor is controlled based on the acceleration data.

13. The method according to claim 12, wherein determining the reduced anti-noise signal comprises selecting a set of filter coefficients for an ANC filter from a group comprising at least two sets of filter coefficients based on the acceleration data.

14. An active noise cancellation processor comprising a processor and memory, wherein the processor is configured to perform the method according to claim 1.

15. A computer program product comprising instructions which, when the program is executed by a computer, cause the computer to carry out the method according to claim 1.
